(19) United States
(12) Patent Application Publication
(10) Pub. No.: US 2021/0149352 A1
(43) Pub. Date: May 20, 2021

(54) BUILDING MANAGEMENT SYSTEM WITH INVOLVEMENT USER INTERFACE

(71) Applicant: Johnson Controls Technology Company, Auburn Hills, MI (US)

(72) Inventors: Ann M. Cook, Hartland, WI (US); Dana A. Guthrie, St. Francis, WI (US); Suvidha Raina, Milwaukee, WI (US); Philip G. Johnson, Muskego, WI (US); Ryan A. Piaskowski, Milwaukee, WI (US); Prashant Taralkar, Milwaukee, WI (US)

(73) Assignee: Johnson Controls Technology Company, Auburn Hills, MI (US)

(21) Appl. No.: 16/688,440

(22) Filed: Nov. 19, 2019

(51) Int. Cl. G05B 15/02; G06F 3/0482

(52) U.S. Cl. CPC G05B 15/02; G06F 3/0482

(57) ABSTRACT

A method in a Building Management System (BMS) includes presenting a user interface to a user on a user device that allows the user to efficiently view logical relationships between objects in the BMS. The method includes presenting, on the user interface, a first object and a second object. The second object is affected by the first object. The first object is presented on a first side of the second object on the user interface. The method also includes receiving, via the user interface, an input from the user including a selection of the second object, and presenting, on the user interface, a third object used to control equipment of the BMS in response to the input from the user. The third object is affected by the second object and presented on a second side of the second object opposite the first side.

### BACKGROUND

The present disclosure relates generally to a building management system (BMS) and more specifically to user interfaces associated with the BMS. A BMS is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof. These systems can require significant amounts of time and effort to configure properly. In addition, users may struggle to understand all of the information contained in such systems.

### SUMMARY

One implementation of the present disclosure is a method in a building management system (BMS). The method includes presenting a user interface to a user on a user device; presenting, on the user interface, a first object used to control equipment of the BMS; presenting, on the user interface, a second object used to control equipment of the BMS, the second object affected by the first object, the first object presented on a first side of the second object on the user interface; receiving, via the user interface, an input from the user, the input including a selection of the second object; and presenting, on the user interface, a third object used to operate equipment of the BMS responsive to the input from the user, the third object affected by the second object and presented on a second side of the second object, the second side opposite the first side.

In some embodiments, the method further includes presenting, on the user interface, a fourth object used to control equipment of the BMS, the first object affected by the fourth object, the fourth object presented on a second side of the first object opposite the first side of the second object.

In some embodiments, the input from the user is a first input, and the method further includes receiving, via the user interface, a second input from the user, the second input including a selection of the fourth object; and presenting, on the user interface, a fifth object used to control equipment of the BMS, the fourth object affected by the fifth object, the fifth object presented on a second side of the fourth object opposite the second side of the first object.

In some embodiments, the method further includes removing, from the user interface, the fourth object responsive to the input from the user.

In some embodiments, the method further includes presenting, on the user interface, a connector between the first object and the second object, wherein the connector identifies a logical relationship between the first object and the second object.

In some embodiments, the connector is interactive and allows the user to view a priority associated with the logical relationship between the first object and the second object.

In some embodiments, a value or state associated with the first object is equal to a value or state associated with the second object, and the method further includes presenting, on the user interface, a visual indication that accentuates the connector.

In some embodiments, the third object is an unbound object that is no longer valid within the BMS, and the method further includes presenting, on the user interface, a visual indication that alerts the user of the unbound object.

In some embodiments, the method further includes presenting, on the user interface, an object address associated with the first object, the object address selectable by the user to navigate to a settings page associated with the first object.

Another implementation of the present disclosure is a BMS including one or more processors and one or more computer-readable storage media having instructions stored thereon that, when executed by the one or more processors, cause the one or more processors to implement operations. The operations include presenting a user interface to a user on a user device; presenting, on the user interface, a first object used to control equipment of the BMS; presenting, on the user interface, a second object used to control equipment of the BMS, the first object affected by the second object, the first object presented on a first side of the second object on the user interface; receiving, via the user interface, an input from the user, the input including a selection of the second object; and presenting, on the user interface, a third object used to control equipment of the BMS responsive to the input from the user, the second object affected by the third object, the third object presented on a second side of the second object, the second side opposite the first side.

In some embodiments, the operations further include presenting, on the user interface, a fourth object used to control equipment of the BMS, the first object affected by the fourth object, the fourth object presented on a second side of the first object opposite the first side of the second object.

In some embodiments, the input from the user is a first input, and the operations further include receiving, via the user interface, a second input from the user, the second input including a selection of the fourth object; and presenting, on the user interface, a fifth object used to control equipment of the BMS, the fifth object affected by the fourth object, the fifth object presented on a second side of the fourth object opposite the second side of the first object.

In some embodiments, the operations further include removing, from the user interface, the fourth object responsive to the input from the user.

In some embodiments, the operations further include presenting, on the user interface, a connector between the first object and the second object, wherein the connector identifies a logical relationship between the first object and the second object.

In some embodiments, the third object is an unbound object that is no longer valid within the BMS, and the operations further include presenting, on the user interface, a visual indication that alerts the user of the unbound object.

Yet another implementation of the present disclosure is a device in a BMS. The device includes one or more processing circuits configured to implement operations, including presenting a user interface to a user on a user device; presenting, on the user interface, a first object used to control equipment of the BMS; presenting, on the user interface, a second object used to control equipment of the BMS, the second object affected by the first object, the first object presented on a first side of the second object on the user interface; receiving, via the user interface, an input from the user, the input including a selection of the second object; and presenting, on the user interface, a third object used to control equipment of the BMS responsive to the input from the user, the third object affected by the second object and presented on a second side of the second object, the second side opposite the first side.

In some embodiments, the operations further include presenting, on the user interface, a fourth object used to control equipment of the BMS, the first object affected by the fourth object, the fourth object presented on a second side of the first object opposite the first side of the second object.

In some embodiments, the input from the user is a first input, and the operations further include receiving, via the user interface, a second input from the user, the second input including a selection of the fourth object; and presenting, on the user interface, a fifth object used to control equipment of the BMS, the fourth object affected by the fifth object, the fifth object presented on a second side of the fourth object opposite the second side of the first object.

In some embodiments, the operations further include presenting, on the user interface, a connector between the first object and the second object, wherein the connector identifies a logical relationship between the first object and the second object.

In some embodiments, the third object is an unbound object that is no longer valid within the BMS, and the operations further include presenting, on the user interface, a visual indication that alerts the user of the unbound object.

Those skilled in the art will appreciate this summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a HVAC system, according to some embodiments.

FIG. 2 is a schematic of a waterside system which can be used as part of the HVAC system of FIG. 1, according to some embodiments.

FIG. 3 is a block diagram of an airside system which can be used as part of the HVAC system of FIG. 1, according to some embodiments.

FIG. 4 is a block diagram of a BMS which can be used in the building of FIG. 1, according to some embodiments.

FIG. 5 is a block diagram of a server associated with the BMS of FIG. 4, according to some embodiments.

FIG. 6 is a drawing of an example involvement user interface associated with the BMS of FIG. 4, according to some embodiments.

FIG. 7 is a drawing of another example involvement user interface associated with the BMS of FIG. 4 that provides an example of how the involvement user interface responds to a user input, according to some embodiments.

FIG. 8 is a drawing of another example involvement user interface associated with the BMS of FIG. 4 that provides an example of priority, according to some embodiments.

FIG. 9 is a drawing of another example involvement user interface associated with the BMS of FIG. 4 that provides an example of an unbound object, according to some embodiments.

FIG. 10 is a flow diagram of an example process for presenting logical relationships between objects associated with the BMS of FIG. 4 to a user via a user interface, according to some embodiments.

### DETAILED DESCRIPTION

### Overview

Referring generally to the FIGURES, a BMS with an involvement user interface is shown, according to various embodiments. The involvement user interface functionality allows users of the BMS to easily identify and troubleshoot various problems by illustrating logical relationships between various objects on a single, intuitive user interface.

The involvement user interface may improve current troubleshooting processes, which typically require users to have significant knowledge of the BMS and may require users to spend long periods of time navigating through a user interface to identify logical relationships between objects. For example, in some previous systems, the easiest way for users to identify logical relationships between objects may be to delete an object and observe effects of the deletion. The involvement user interface may significantly decrease troubleshooting time by providing users with an interactive visual representation of logical relationships between objects. Additionally, the involvement user interface may allow a variety of different personnel (e.g., operators, administrators) to achieve a better understanding of the BMS configuration, thereby providing improved efficiency in operating and maintaining the BMS.

### Building Management System

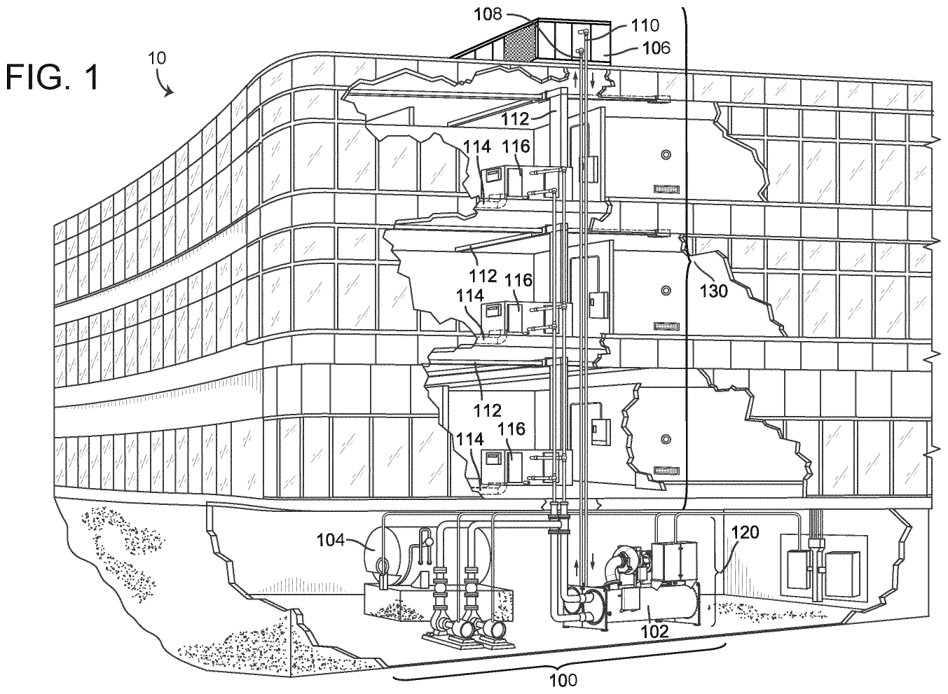

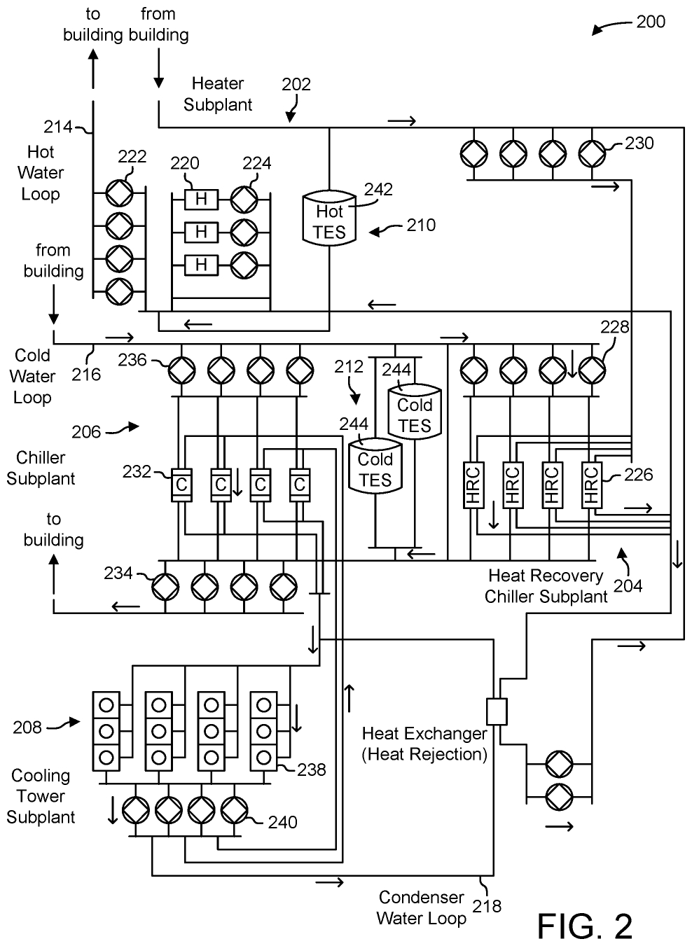

Referring now to FIG. 1, a perspective view of a building 10 is shown. Building 10 is served by a BMS (sometimes referred to as a building automation system (BAS)). The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a central plant 200 is shown, according to an exemplary embodiment. In brief overview, central plant 200 may include various types of equipment configured to serve the thermal energy loads of a building or campus (i.e., a system of buildings). For example, central plant 200 may include heaters, chillers, heat recovery chillers, cooling towers, or other types of equipment configured to serve the heating and/or cooling loads of a building or campus. Central plant 200 may consume resources from a utility (e.g., electricity, water, natural gas, etc.) to heat or cool a working fluid that is circulated to one or more buildings or stored for later use (e.g., in thermal energy storage tanks) to provide heating or cooling for the buildings. In various embodiments, central plant 200 may supplement or replace waterside system 120 in building 10 or may be implemented separate from building 10 (e.g., at an offsite location).

Central plant 200 is shown to include a plurality of subplants 202-212 including a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO₂, etc.) may be used in place of or in addition to water to serve the thermal energy loads. In other embodiments, subplants 202-212 may provide heating and/or cooling directly to the building or campus without requiring an intermediate heat transfer fluid. These and other variations to central plant 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in central plant 200 (e.g., pumps 222, 224, 228, 230, 234, 236, and/or 240) or pipelines in central plant 200 include an isolation valve associated therewith. Isolation valves may be integrated with the pumps or positioned upstream or downstream of the pumps to control the fluid flows in central plant 200. In various embodiments, central plant 200 may include more, fewer, or different types of devices and/or subplants based on the particular configuration of central plant 200 and the types of loads served by central plant 200.

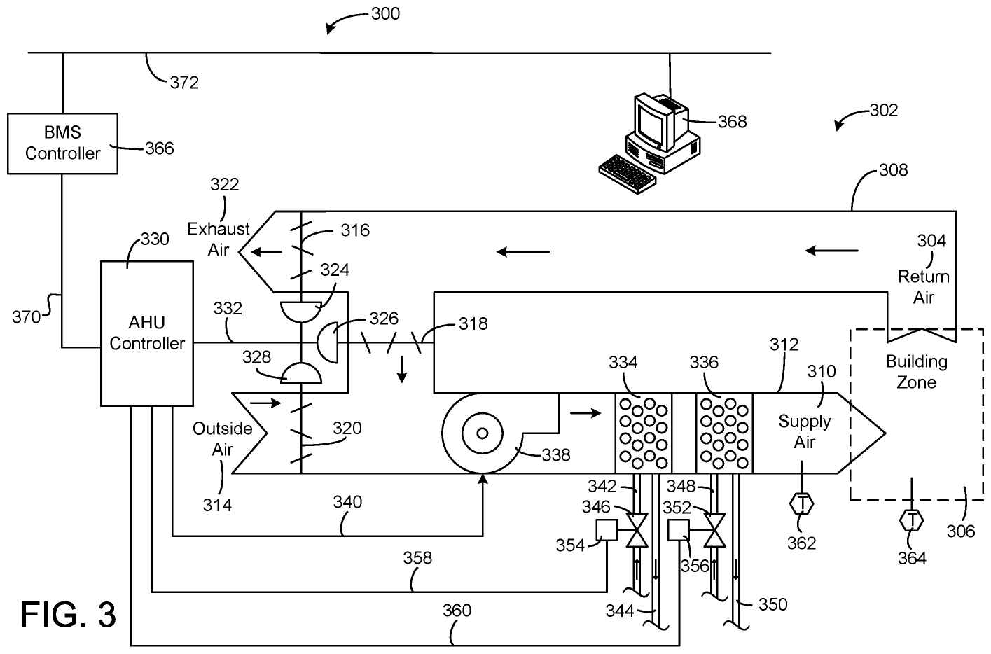

Referring now to FIG. 3, a block diagram of an airside system 300 is shown, according to an example embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, duct 112, duct 114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360.

Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362 and 364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

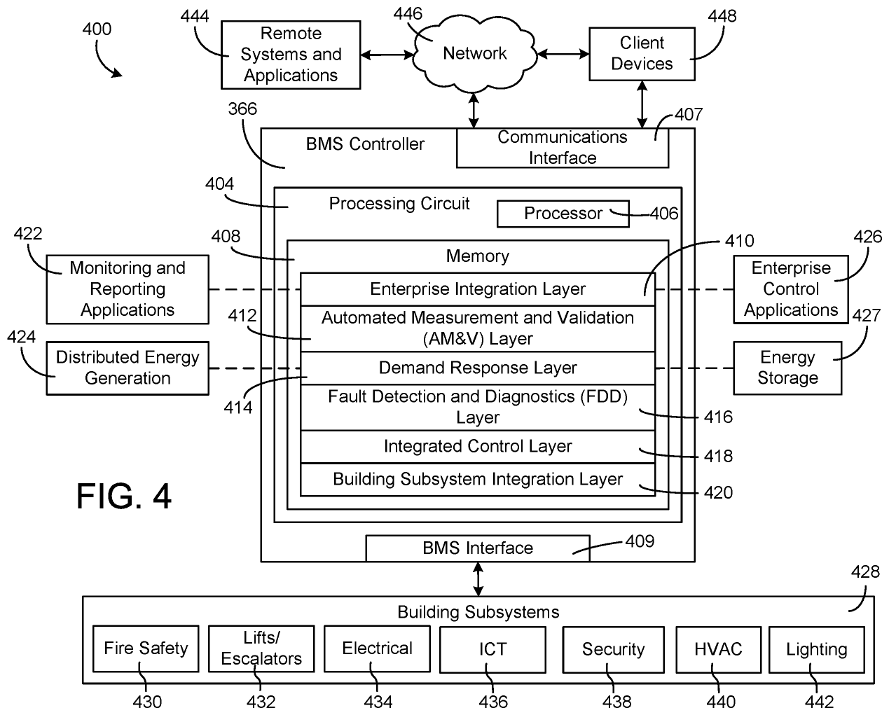

Referring now to FIG. 4, a block diagram of a BMS 400 is shown, according to an example embodiment. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated super system. In an example embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Involvement User Interface

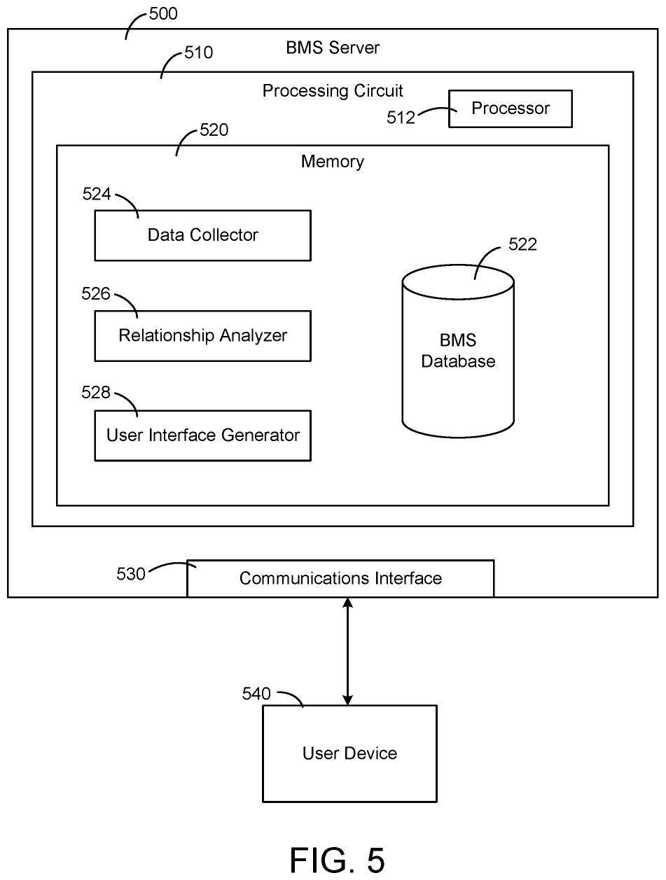

Referring now to FIG. 5, a block diagram of a server 500 associated with BMS 400 is shown, according to some embodiments. Server 500 can be configured to generate and present an involvement user interface to a user of BMS 400 on a user device 540. The involvement user interface generally allows the user to view logical relationships between building objects in an intuitive, user-friendly manner. This functionality may allow users to achieve a better understanding of logical relationships within BMS 400, thereby leading to improved efficiency for the user with respect to system configuration and troubleshooting. The involvement user interface may present a selected object near the center of the user interface, in addition to presenting input objects that affect the selected object and output objects that are affected by the selected object on opposing sides of the user interface. In this manner, the user may easily view all logical relationships associated with the selected object in a single view.

Server 500 can be implemented within BMS 400 in a variety of ways. For example, server 500 may be a network device such as a network engine or a controller such as BMS controller 366. Server 500 may also be a workstation, personal computer or another type of device similar to client device 368 with server software installed thereon. Server 500 may also be implemented using one or more on-premises server computers and/or one or more remote cloud-based server computers. In this sense, server 500 may be distributed across a variety of physical hardware devices. Server 500 may generally provide services for various client devices associated with BMS 400. Server 500 is shown to include a processing circuit 510 that includes a processor 512 and a memory 520. It will be appreciated that these components can be implemented using a variety of different types and quantities of processors and memory. Server 500 is also shown to include a communications interface 530 configured to send data to and receive data from user device 540. Communications interface 530 may also be in communication with equipment of BMS 400 such as BMS controller 366. For example, communications interface 530 may include a wired and/or wireless BACnet interface in addition to other types of communications interfaces (e.g., Modbus, LonWorks, DeviceNet, WL, etc.).

User device 540 may be any electronic device that allows a user to interact with BMS 400 through a user interface. Examples of user devices include, but are not limited to, mobile phones, electronic tablets, laptops, desktop computers, workstations, and other types of electronic devices. User device 540 may be similar to client device 368 as described above. User device 540 may display the involvement user interface on a display, thereby enabling a user to easily view and troubleshoot objects associated with BMS 400.

Memory 520 is shown to include a BMS database 522 that can be configured to store a variety of data associated with BMS 400. For example, BMS database 522 can generally maintain historical data including trend data, event data, alarm data, operator transaction data, as well as system configuration data. System configuration data can include configuration data related to spaces, equipment, points, controllers, network engines, and other configuration data related to BMS 400. The historical data maintained by BMS database 522 may generally be associated with any of the equipment described above. For example, BMS database 522 may include sensor readings and other data associated with BMS 400. BMS server 500 can access data from BMS database 522 in order to generate and present the involvement user interface to a user. It will be appreciated that BMS database 522 can be implemented as a single database or multiple separate databases working together.

BMS 400 can generally be configured to access and manipulate data using an object-oriented approach. For example, BMS 400 may utilize a variety of different types of objects to perform functions such as automated measurement and validation, demand response, fault detection and diagnostics, and other functions such as described above. Each object can include associated attributes and methods representative of physical equipment and devices in building 10. Objects associated with BMS 400 can interact with each other and can be stored and maintained in BMS database 522. In this manner, objects can be used to control equipment of BMS 400. Software defined building objects are described in more detail in U.S. patent application Ser. No. 12/887,390, filed Sep. 21, 2010, the entirety of which is incorporated by reference herein.

Memory 520 is also shown to include a data collector 524 that can be configured to collect and format data associated with BMS 400. For example, data collector 524 can be configured to collect live data from building equipment (e.g., via communications interface 530) such as real-time readings from a temperature sensor, flow sensor, supply fan, etc., which may include a current state or value (e.g., true, false, off, temperature, flow rate, etc.). Data collector 524 may also retrieve historical data (e.g., trend data, event data, alarm data, operator transaction data, system configuration data, etc.) and reference objects from BMS database 522.

Memory 520 is also shown to include a relationship analyzer 526. Relationship analyzer 526 can be configured to analyze and identify logical relationships between two or more objects. In some embodiments, logical relationships between objects may include commands (e.g., “commanded by”, “commands”), references (e.g., “referenced by”, “references”), or other functions (e.g., “written to”, “writes”). For example, relationship analyzer 526 may analyze a first object (e.g., a schedule object) and a second object (e.g., a photocell object) and determine that the first object is commanding the second object to perform an action (e.g., turn photocells on). Relationship analyzer 526 may also identify the priority array associated with the object relationship. To continue the previous example, the first object may command the second object to perform the action at priority value of 6, while a third object (e.g., an interlock object) may command the second object to perform another action (e.g., turn photocells off) at a higher priority value of 3. The logical relationships analyzed and identified by relationship analyzer 526 can be used to populate a relationship tree and may be compiled for presentation on the user device 540.

Memory 520 is also shown to include a user interface generator 528. User interface generator 528 may be configured to generate the involvement user interface that may be presented on user device 540. User interface generator 528 may utilize a diagramming library (e.g., yFiles, JGraph, Mermaid, Rappid, etc.) and/or other similar method to generate the involvement user interface, for example. The involvement user interface may include objects, object properties (e.g., object name, object identifier, object type, object address, object status, object state, etc.), and connectors that illustrate the logical relationships between objects. User interface generator 528 may retrieve information on object properties from data collector 524 and may retrieve information logical relationships between objects from relationship analyzer 526. User interface generator 528 may be implemented as a webserver that can store, process, and deliver web pages (e.g., HTML documents) to a web browser of a user device 540, or as an application on a user device 540 (e.g., desktop application, mobile application), for example. User interface generator 528 may generally receive inputs (e.g., HTTP requests) from user device 540.

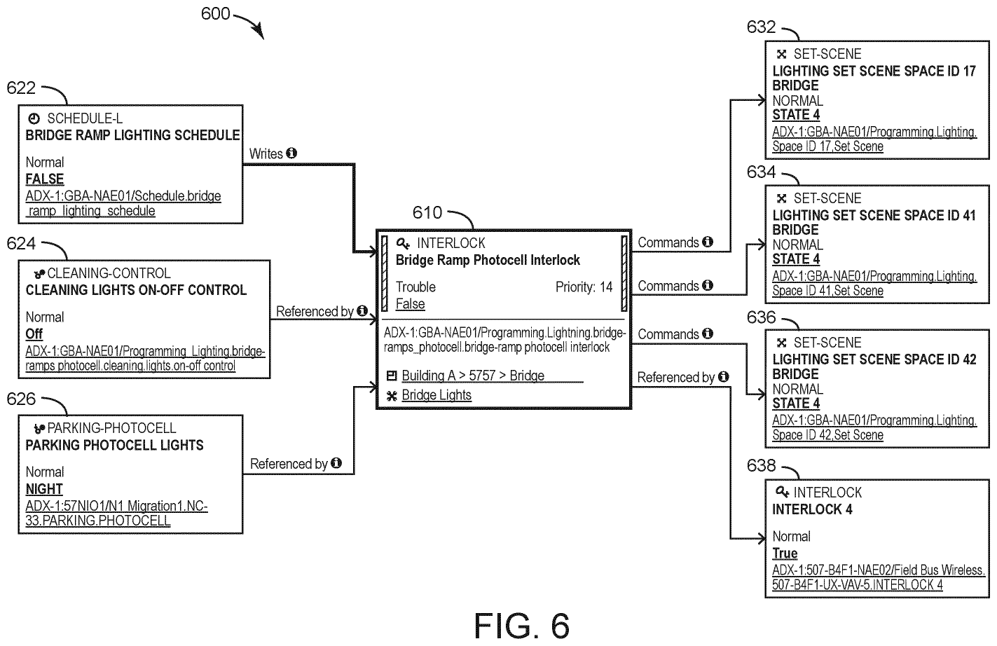

In some embodiments, user interface generator 528 may present objects in the form of graphical elements, such as object blocks. Logical relationships between objects may be presented in the form of connectors (e.g., lines, arrows) between object blocks. Object blocks and connectors presented via the involvement user interface may include textual or graphical representations of information such as object properties (e.g., object name, object identifier, object address, object condition, object state, etc.), logical relationship types (e.g., commands, references, functions), and priorities, as shown for example in FIG. 6, described in more detail below. For example, user interface generator 528 may present an object (e.g., an interlock object) via the involvement user interface. The object may be presented in the form of an object block, where the object block includes the object name, the object type, the object's current condition and status, and the object address. Object blocks and the information contained therein may be selectable by a user of user device 540, such that selecting the block displays additional information about the object properties. The object block may also include a link which, after being selected by a user of user device 540, presents additional properties of the selected object block or navigates the user to a page associated with the object. From this object page, the user may view more detailed information about the object and make edits to various properties associated with the object. In other embodiments, the user interface generator 528 may present objects in using textual or graphical representations other than object blocks and connectors.

In another example, user interface generator 528 may present three object blocks on the involvement user interface. If a first object block commands a second object block, the logical relationship between the object blocks may be identified as “commands” on a connector shown between the first and second object blocks on the user interface. If a third object block is referenced by the second object block, the logical relationship between the object blocks may be identified as “referenced by” on a connector shown between the second and third object blocks on the user interface. A user of user device 540 may view additional information about the logical relationship between the objects blocks by selecting the connector or, in some embodiments, an information icon near the connector. Upon receiving a user selection of the connector (or information icon) between two objects, the user interface generator may present the priorities associated with the relationship between the two objects. The ability to view object relationships, including details on object logical relationships (e.g., priority), may allow administrators to more efficiently troubleshoot objects associated with BMS 400 by quickly identifying where a problem may exist and how related objects may impact the problem objects.

In some embodiments, user interface generator 528 may provide a user of user device 540 with a progressive disclosure of information relating to object blocks and/or logical relationship connectors between object blocks. Progressive disclosure allows the user to zoom-in and zoom-out on the involvement user interface, thereby being presented with more or less information relating to the object blocks and/or logical relationship connectors presented on the involvement user interface. For example, the user may zoom-out on the involvement user interface to view a plurality of object blocks and the logical relationship connectors between the object blocks being presented. The user may then zoom-in on an object block, or a logical relationship connector between two object blocks, to view additional information about said object block or logical relationship connector. In this example, a user may be presented with limited information when the involvement user interface is zoomed-out (e.g., the object block includes only one of the object's name, type, current condition and status, or address), and information may be added to the involvement user interface as the user zooms-in (e.g., one or more of the object's name, type, current condition and status, or address, not previously presented, are presented via the involvement user interface).

Referring now to FIG. 6, an example involvement user interface 600 is shown, according to some embodiments. Interface 600 can be presented on user device 540 by BMS server 500, for example. Interface 600 is shown to include a plurality of objects associated with BMS 400 and logical relationships therebetween. Interface 600 may allow a user of user device 540 to quickly identify an object's properties, the input and output objects that impact it, and the logical relationships between these objects. By presenting this information in a single display, users may be able to troubleshoot BMS 400 more efficiently, thereby removing the need to navigate through various user interface screens to find desired object information. As described above, a user may be able to zoom-in and zoom-out on interface 600 to view more or less information about each of the object blocks and logical relationships connections presented.

Interface 600 is shown to include an interlock object 610 that is presented at or near the center of interface 600. Interlock object 610 may be a “selected object” that is selected by the user because the user wishes to view logical relationships associated with interlock object 610. Interface 600 presents both input objects that affect interlock object 610 as well as output objects that are affected by interlock object 610. The input objects and the output objects are presented on opposing sides of interlock object 610 interface 600. In this manner, the user can easily view all logical relationships associated with interlock object 610 in a single view.

Interlock object 610 may generally provide a means for establishing conditional control over one or more other objects. As shown in interface 600, interlock object 610 establishes conditional control over multiple light scene objects (as discussed in more detail below). Interlock object 610 may include a conditional statement as well as true command statements and false command statements to specify a set of conditional checks for which commands are used to control the light scene objects. Interlock object 610 may also be affected by other objects such as a schedule object (as discussed in more detail below). In some previous approaches, users may struggle to identify each of the objects affected by interlock object 610 as well as each of the objects that affect interlock object 610.

As shown, interface 600 may present various information associated with interlock object 610 such as an object identifier (“Interlock”), an object name (“Bridge Ramp Photocell Interlock”), a current status (“Trouble”), current state or value (“False”), current priority (“Priority: 14”), an object address (e.g., in BMS database 522), a space (“Building A>5757>Bridge”), and one or more links that allow the user to navigate to a settings page associated with interlock object 610 (“Bridge Lights”). In this manner, interface 600 not only allows the user to view logical relationships associated with interlock object 610, but it also allows the user to view a variety of information about interlock object 610 and provides an efficient means for editing settings associated with interlock object 610.

As shown, interface 600 presents logical relationships between object using different types of connectors. For example, interface 600 is shown to include a connector indicating that a lighting schedule object 622 writes to interlock object 610. Interface 600 is also shown to include a connector indicating that a cleaning control object 624 is referenced by interlock object 610 and a connector indicating that a parking photocell object 626 is referenced by interlock object 610. Further, interface 600 is shown to include a connector indicating that a light scene object 632 is commanded by interlock object 610, a connector indicating that another light scene object 634 is commanded by interlock object 610, a connector indicating that yet another light scene object 636 is commanded by interlock object 610, and a connector indicating that another interlock object 638 references interlock object 610. Notably, the objects that affect interlock object 610 (e.g., input objects) are presented on the left side of interlock object 610 and the objects that are affected by interlock object 610 (e.g., output objects) are presented on the right side of interlock object 610 on interface 600.

In some embodiments, when an output (e.g., a state or value) of a first object block is equivalent to the input of the selected object block, a logical relationship connector between the two objects blocks may be presented as a bold line. For example, and as shown in interface 600, lighting schedule object 622 writes to interlock object 610. The bold logical relationship connector between lighting schedule object 622 and interlock object 610 indicates that the current state or value of lighting schedule object 622 (“False”) is being written to interlock object 610, shown with a current state or value of “False.” In some embodiments, an object block may be highlighted (e.g., made bold) to indicate that the object block is pushing an output state or value that is equivalent to the input of another object block. For example, if an occupancy object has a current state of “Occupied,” a schedule object that is writing “Occupied” to the occupancy object may be highlighted. Any type of visual indication that accentuates a connector between objects with an equivalent state or value may be presented on the involvement user interface.

Similar to interlock object 610, interface 600 is shown to present a variety of information associated with each input object and each output object associated with interlock object 610. For example, lighting schedule object 622 is shown to include an object identifier (“Schedule”), an object name (“Bridge Ramp Lighting Schedule”), a current status (“Normal”), a current state or value (“False”), and an object address (e.g., in BMS database 522). Lighting schedule object 622 may generally provide a means for updating the attributes of one or more other objects at specified times, days, and dates. Lighting schedule object 622 may include a time/value pair that describes the time, day, or date that an attribute of another object changes to a defined state or value. As shown in interface 600, lighting schedule object 622 updates the attributes of interlock object 610 by writing a state or value to interlock object 610.

Interface 600 is also shown to present a variety of information associated with cleaning control object 624 including an object identifier (“Cleaning—Control”), an object name (“Cleaning Lights On—Off Control”), a current status (“Normal”), a current state or value (“Off”), and an object address (e.g., in BMS database 522). Cleaning control object 624 may generally be a command object, providing a means for controlling one or more other objects, such as multiple photocells (e.g., cleaning lights). Cleaning control object 624 may include a state or value (e.g., on/off) that commands the value or state of one or more other objects to that state or value. For example, cleaning control object 624 may command multiple photocells (“cleaning lights”) to the “on” state. As shown in interface 600, cleaning control object 624 is referenced by interlock object 610.

Interface 600 is also shown to present a variety of information associated with parking photocell object 626 including an object identifier (“Parking—Photocell”), an object name (“Parking Photocell Lights”), a current status (“Normal”), a current state or value (“Night”), and an object address (e.g., in BMS database 522). Parking photocell object 626 may generally be a command object, providing a means for controlling one or more other objects, such as multiple photocells (e.g., parking photocell lights). Parking photocell object 626 may include a state or value (e.g., day/night) that commands the value or state of one or more other objects to that state or value. For example, parking photocell object 626 may command multiple photocells (“parking photocell lights”) to the “night” state, where “night” may be a predefined state or value for one or more photocell objects controlled by the parking photocell object 626. As shown in interface 600, parking photocell object 626 is referenced by interlock object 610.

Light scene objects 632-636 are shown to include an object identifier (“Set-Scene”), an object name (e.g., “Lighting Set Scene Space ID 17 Bridge”), a current status (“Normal”), a current state or value (“State 4”), and an object address (e.g., in BMS database 522). Light scene objects 632-636 may generally be multi-state value objects that set a static or dynamic value for multiple light fixtures in a space (e.g., a room in building 10). For example, light scene object 632 may write or command a value, “State 4,” to all of the light fixtures of “space ID 17.” As shown in interface 600, interlock object 610 commands light scene objects 632-636.

Interlock object 638 is shown to include an object identifier (“Interlock”), an object name (“Interlock 4”), a current status (“Normal”), a current state or value (“True”), and an object address (e.g., in BMS database 522). Similar to interlock object 610, interlock object 638 may generally provide a means for establishing conditional control over one or more other objects. As shown in interface 600, interlock object 638 is referenced by interlock object 610.

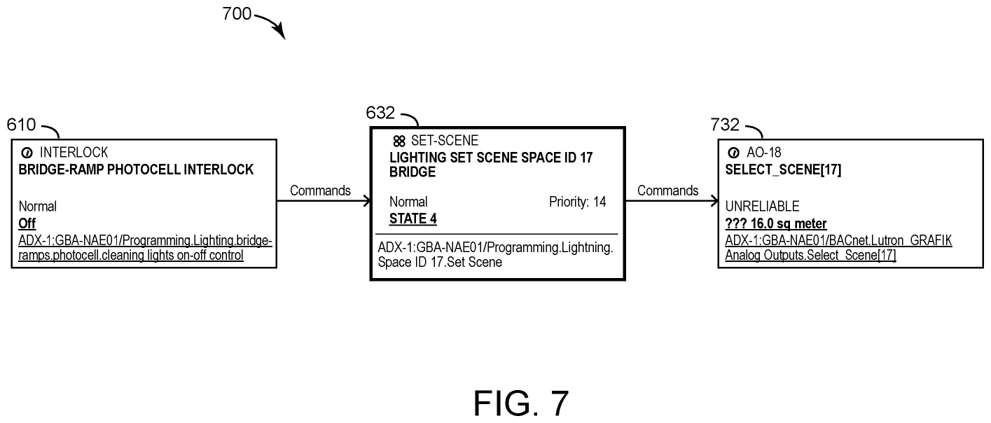

Referring now to FIG. 7, another example involvement user interface 700 is shown, according to some embodiments. Interface 700 may be presented by BMS server 500 on user device 540, for example. Interface 700 may be presented to the user after the user selects light scene object 632 via interface 600. Responsive to receiving this user input consisting of a selection of light scene object 632, BMS server 500 may update the involvement user interface such that light scene object 632 becomes the new selected object. In this manner, the user can now easily view all logical relationships associated with light scene object 632. Interface 700 is shown to include an analog output object 732 that is commanded by light scene object 632. Accordingly, interface 700 is shown to include a connector indicating that that analog output object 732 is commanded by light scene object 632. Interface 700 is also shown to include interlock object 610 and a connector indicating that light scene object 632 is commanded by interlock object 610.

In becoming the new selected object, BMS server 500 may present additional information regarding light scene object 632 in interface 700 than presented in interface 600. For example, light scene object 632 is shown to include an indication of priority (e.g., “Priority: 14”) in interface 700, but not in interface 600. Additionally, BMS server 500 may present less information about objects that have been “unselected” such as interlock object 610 as shown in interface 700. For example, interlock object 610 as shown in interface 700 does not include priority information or space information as was shown in interface 600 since interlock object 610 is no longer the selected object.

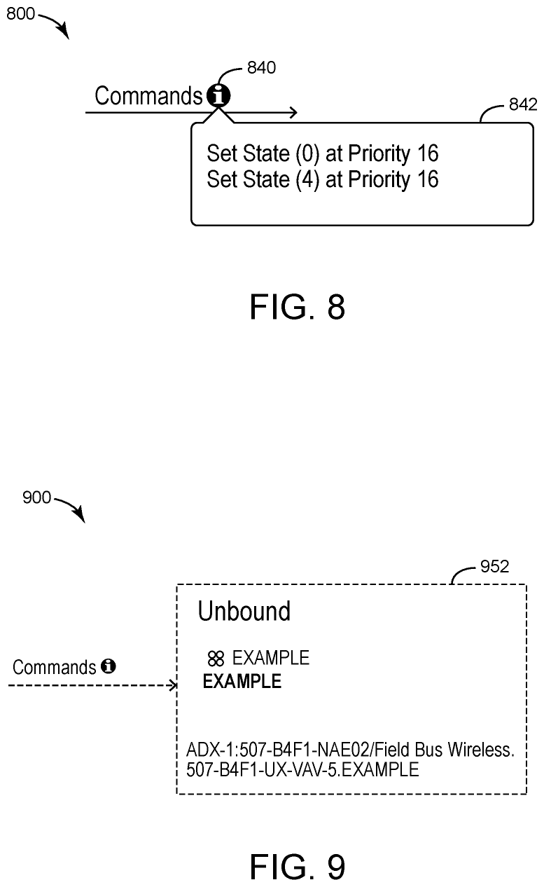

Referring now to FIG. 8, another example involvement user interface 800 showing an example of priority is shown, according to some embodiments. Interface 800 may be presented by BMS server 500 on user device 540, for example. It will be appreciated that interface 800 only shows a portion of a full involvement user interface and is intended to show an example of priority functionality. Interface 800 may be displayed when the user selects a connection between two objects. For example, a connector may include an information icon 840 as shown in interface 800. The user may select information icon 840 in order to view information about the connection between two objects. After receiving the user input including a selection of information icon 840, as shown in interface 800, BMS server 500 may present a text box 842 that presents details about the logical relationship indicated by the connector. Details presented in text box 842 may include priorities, the values that one object is writing to another, the data that one object is commanding to another, the information that one object references from another, and other information. For example, a first object may command a second object to set the second object's state to “on” at priority 4 in a priority array. In some embodiments, text box 842 is an interactive dialog box that the user can interact with in order to affect the logical relationship indicated by the connector.

In allowing the user to view information regarding logical relationships between objects via interface 800, such as the priority array information shown in text box 842, the involvement user interface may facilitate improved troubleshooting and system management capabilities. Interface 800 may allow the user to quickly determine how two objects are interacting and view information on priority array data on such object interactions. Priority array information may be beneficial to users when troubleshooting or interacting with BMS 400 by allowing users to determine what values and/or states are being commanded and/or written, and at what priority these values and/or states are being commanded and/or written. For example, problems may arise if two different states or values (e.g., “State (0)” and “State (4)”) are commanded at the same priority level (e.g., “Priority 15”). Interface 800 may allow a user to quickly identify and correct this discrepancy.

Referring now to FIG. 9, another example involvement user interface 900 showing an example of an unbound object 952 is shown, according to some embodiments. Interface 900 may be presented by BMS server 500 on user device 540, for example. It will be appreciated that interface 900 only shows a portion of a full involvement user interface and is intended to show an example of unbound object functionality. Similar to other objects presented on the involvement user interface, a variety of attributes may be presented with unbound object 952 such as an object identifier (“Unbound”), an object name (“Example”), and an object address (e.g., in BMS database 522). However, unlike other object presented on the involvement user interface, unbound object 952 may be presented using dotted lines as shown in interface 900 or other similar visual indications alerting the user of the unbound object. As shown in interface 900, the connector associated with unbound object 952 may also be presented as a dotted line.

Interface 900 may be presented when a user selects an object that has been moved or deleted (e.g., within BMS database 522), thereby causing the object link to become invalid. Interface 900 may also be presented when a selected object has a logical relationship with an unbound object (e.g., an input or output object of a selected object). Unbound objects are generally objects that are not bound in BMS 400, such that the object and/or object properties cannot be located due to the object's reference within the system being incorrect (e.g., having been moved or deleted). In this sense, unbound objects may be invalid objects that unintentionally affect other, valid objects, thereby unnecessarily consuming memory or other system resources. References to unbound objects may have been valid at a previous time, however may no longer be valid.

Interface 900 may aid a user in troubleshooting a problem object by identifying unbound objects which may be affecting the problem object. For example, a selected object may reference an unbound object, thereby causing a problem with the selected object, as the unbound object has been moved or deleted and the reference, therefore, is no longer valid. Additionally, the involvement user interface may allow the user to “clean-up” invalid objects and object references (e.g., by removing from BMS database 522). For example, the user may choose to delete unbound objects that are connected to a selected object, as the logical relationship between the selected object and the unbound object is unnecessary, such that unbound objects cannot be commanded or written to by the selected object. The user may be unaware such that unbound objects exists before interacting with the involvement user interface.

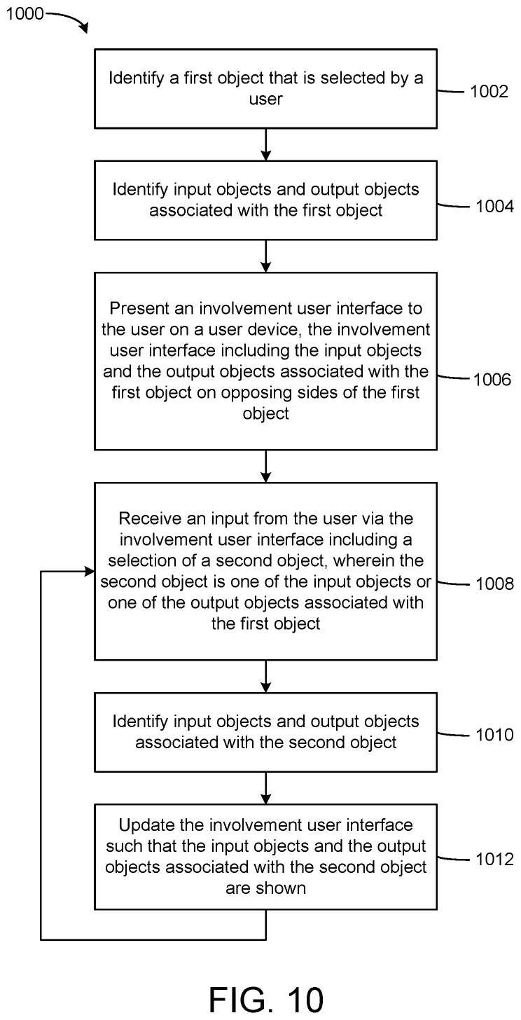

Referring now to FIG. 10, an example process 1000 for presenting logical relationships between objects in a BMS to a user via a user interface is shown, according to some embodiments. Process 1000 can be performed by BMS server 500 in communication with a user via user device 540, and the user interface may be the involvement user interface as described above, for example. Process 1000 generally provides the user with the ability to navigate through object relationships efficiently, thereby allowing the user to identify how objects impact one another and providing traceability though BMS 400. As discussed above, the involvement user interface generally includes a plurality of objects associated with BMS 400 and logical relationships therebetween. The involvement user interface may allow a user to quickly identify object properties, the input and output objects that impact it, and the logical relationships between objects.

Process 1000 is shown to include identifying a first object that is selected by the user (step 1002). For example, the first object may be interlock object 610 (e.g., the selected object) as described above. A user may select the first object as part of a troubleshooting procedure when building equipment (e.g., subplants, chiller arrays, etc.) or individual devices (e.g., individual chillers, heaters, pumps, etc.) are not functioning properly. For example, a section of bridge lights may be operating incorrectly (e.g., at an incorrect state or value, in a trouble status, etc.), prompting the user to inspect building objects which are known to affect the bridge lights. In this example, the user may select interlock object 610, which is named “Bridge Ramp Photocell Interlock,” and generally provides means for establishing conditional control over one or more other objects (e.g., bridge ramp photocells), to begin the troubleshooting process.

Process 1000 is also shown to include identifying input objects and output objects associated with the first object (step 1004). For example, step 1004 may include identifying lighting schedule object 622, cleaning control object 624, and parking photocell object 626, as described above, as input objects associated with interlock object 610. Step 1004 may also include identifying light scene objects 632-636 and interlock object 638, as described above, as output objects associated with interlock object 610. Generally, the input objects are objects that affect the first object and the output objects are objects that are affected by the first object. For example, lighting schedule object 622 writes to interlock object 610, and light scene object 632 is commanded by interlock object 610. Identifying objects in step 1004 may also include identifying object properties for each of the input objects and the output objects, such as the object name, identifier, type, status, value, address, and/or other properties or information. Step 1004 may be performed by relationship analyzer 526 by accessing BMS database 522, for example.

Process 1000 is also shown to include presenting an involvement user interface to the user on a user device, the involvement user interface including the input objects and the output objects associated with the first object on opposing sides of the first object (step 1006). For example, referring back to FIG. 6, interlock object 610 (e.g., the first object) is shown at or near the center of interface 600. The input objects associated with interlock object 610, including lighting schedule object 622, cleaning control object 624, and parking photocell object 626, may be presented on the left side of interlock object 610. The output objects, including light scene objects 632-636 and interlock object 638, may be presented on the right side of interlock object 610. Additionally, the logical relationships and associated connectors between objects may be presented at step 1006. For example, referring again back to FIG. 6, various connectors) are shown between objects that identify logical relationships between the objects as discussed above. The involvement user interface may also provide priority and unbound object functionality as described above with reference to FIG. 8 and FIG. 9.

Process 1000 is also shown to include receiving an input from the user via the involvement user interface including a selection of a second object, wherein the second object is one of the input objects or one of the output objects associated with the first object (step 1008). For example, the user may be troubleshooting bridge lights that are not functioning correctly and, after selecting interlock object 610, the user may learn that light scene objects 632 is commanded by interlock object 610. The bridge lights that are not functioning correctly may be localized to a space, such as “Space ID 17.” A user may identify, via interface 600, that light scene object 632 is identified as a “Set-Scene” object for “Space ID 17,” and subsequently select light scene object 632 to view additional object properties and information associated with light scene object 632.

Process 1000 is also shown to include identifying input objects and output objects associated with the second object (step 1010). For example, after selecting light scene object 632, the input objects, such as interlock object 610, and output objects, such as analog output object 732, may be identified. Similar to step 1004, the input objects are generally objects that affect the second object and the output objects are generally objects that are affected by the second object. For example, interlock object 610 commands light scene object 632, and analog output object 732 is commanded by light scene object 632. Identifying objects at step 1010 may also include identifying object properties for each of the input and output objects, such as the object name, identifier, type, status, value, address, and/or other properties or information.

Process 1000 is also shown to include updating the involvement user interface such that input objects and output objects associated with the second object are shown (step 1012). For example, BMS server 500 may generate interface 700 after receiving the user selection of light scene object 632. Interface 700 is shown to include the second object (light scene 632) at or near the center of the interface, with the input object (interlock object 610) on the left side of light scene object 632 and the output object (analog output object 732) on the right side of light scene object 632. Additionally, the logical relationships between these objects may be presented as connectors between the object blocks. For example, an arrow is shown between light scene object 632 and analog output object 732, indicating that light scene object 632 commands analog output object 732.

The steps of process 1000 may be repeated as the user continues to select different objects. In this manner, a user can easily view relevant object properties and logical relationships associated with the selected object. Process 1000 provides object properties and relationships in an intuitive, single-page overview, thereby removing the need to navigate through various user interface screens to find desired object information. Process 1000 may allow users to achieve a better understanding of logical relationships between objects within a BMS, thereby leading to improved efficiency with respect to system configuration and troubleshooting.

While the involvement user interface as described herein refers to presentation of objects such as BACnet objects, it will be appreciated that a similar approach may be used in systems that do not use an object-oriented approach. For example, a building management system may implement open-source protocols such as Brick Schema and Project Haystack to define building entities. In this example, the involvement user interface may present relationships between Brick Schema entities, and not necessarily “objects” as discussed herein. The use of the term “objects” is not intended to be limiting, and minor variations thereof are contemplated within the scope of this disclosure.

### CONFIGURATION OF EXEMPLARY EMBODIMENTS

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method in a Building Management System (BMS), the method comprising:
presenting a user interface to a user on a user device;
presenting, on the user interface, a first object used to control equipment of the BMS;
presenting, on the user interface, a second object used to control equipment of the BMS, the second object affected by the first object, the first object presented on a first side of the second object on the user interface;
receiving, via the user interface, an input from the user, the input comprising a selection of the second object; and
presenting, on the user interface, a third object used to control equipment of the BMS responsive to the input from the user, the third object affected by the second object and presented on a second side of the second object, the second side opposite the first side.

2. The method of claim 1, further comprising presenting, on the user interface, a fourth object used to control equipment of the BMS, the first object affected by the fourth object, the fourth object presented on a second side of the first object opposite the first side of the second object.

3. The method of claim 2, wherein the input from the user comprises a first input, the method further comprising:
receiving, via the user interface, a second input from the user, the second input comprising a selection of the fourth object; and
presenting, on the user interface, a fifth object used to control equipment of the BMS, the fourth object affected by the fifth object, the fifth object presented on a second side of the fourth object opposite the second side of the first object.

4. The method of claim 2, further comprising removing, from the user interface, the fourth object responsive to the input from the user.

5. The method of claim 1, further comprising presenting, on the user interface, a connector between the first object and the second object, wherein the connector identifies a logical relationship between the first object and the second object.

6. The method of claim 5, wherein the connector is interactive and allows the user to view a priority associated with the logical relationship between the first object and the second object.

7. The method of claim 5, wherein a value or state associated with the first object is equal to a value or state associated with the second object, the method further comprising:
presenting, on the user interface, a visual indication that accentuates the connector.

8. The method of claim 1, wherein the third object comprises an unbound object that is no longer valid within the BMS, the method further comprising:
presenting, on the user interface, a visual indication that alerts the user of the unbound object.

9. The method of claim 1, further comprising presenting, on the user interface, an object address associated with the first object, the object address selectable by the user to navigate to a settings page associated with the first object.

10. A Building Management System (BMS), the system comprising:
one or more processors; and
one or more computer-readable storage media having instructions stored thereon that, when executed by the one or more processors, cause the one or more processors to implement operations comprising:
presenting a user interface to a user on a user device;
presenting, on the user interface, a first object used to control equipment of the BMS;
presenting, on the user interface, a second object used to control equipment of the BMS, the first object affected by the second object, the first object presented on a first side of the second object on the user interface;
receiving, via the user interface, an input from the user, the input comprising a selection of the second object; and
presenting, on the user interface, a third object used to control equipment of the BMS responsive to the input from the user, the second object affected by the third object, the third object presented on a second side of the second object, the second side opposite the first side.

11. The system of claim 10, the operations further comprising presenting, on the user interface, a fourth object used to control equipment of the BMS, the first object affected by the fourth object, the fourth object presented on a second side of the first object opposite the first side of the second object.

12. The system of claim 11, wherein the input from the user comprises a first input, the operations further comprising:
receiving, via the user interface, a second input from the user, the second input comprising a selection of the fourth object; and
presenting, on the user interface, a fifth object used to control equipment of the BMS, the fifth object affected by the fourth object, the fifth object presented on a second side of the fourth object opposite the second side of the first object.

13. The system of claim 11, the operations further comprising removing, from the user interface, the fourth object responsive to the input from the user.

14. The system of claim 10, the operations further comprising presenting, on the user interface, a connector between the first object and the second object, wherein the connector identifies a logical relationship between the first object and the second object.

15. The system of claim 10, wherein the third object comprises an unbound object that is no longer valid within the BMS, the operations further comprising:
presenting, on the user interface, a visual indication that alerts the user of the unbound object.

16. A device in a Building Management System (BMS), the device comprising:
one or more circuits configured to implement operations comprising:
presenting a user interface to a user on a user device;
presenting, on the user interface, a first object used to control equipment of the BMS;
presenting, on the user interface, a second object used to control equipment of the BMS, the second object affected by the first object, the first object presented on a first side of the second object on the user interface;
receiving, via the user interface, an input from the user, the input comprising a selection of the second object; and
presenting, on the user interface, a third object used to control equipment of the BMS responsive to the input from the user, the third object affected by the second object and presented on a second side of the second object, the second side opposite the first side.

17. The device of claim 16, the operations further comprising presenting, on the user interface, a fourth object used to control equipment of the BMS, the first object affected by the fourth object, the fourth object presented on a second side of the first object opposite the first side of the second object.

18. The device of claim 17, wherein the input from the user comprises a first input, the operations further comprising:
receiving, via the user interface, a second input from the user, the second input comprising a selection of the fourth object; and
presenting, on the user interface, a fifth object used to control equipment of the BMS, the fourth object affected by the fifth object, the fifth object presented on a second side of the fourth object opposite the second side of the first object.

19. The device of claim 16, the operations further comprising presenting, on the user interface, a connector between the first object and the second object, wherein the connector identifies a logical relationship between the first object and the second object.

20. The device of claim 16, wherein the third object comprises an unbound object that is no longer valid within the BMS, the operations further comprising:
presenting, on the user interface, a visual indication that alerts the user of the unbound object.
